(19) United States
(12) Patent Application Publication
(10) Pub. No.: US 2011/0289110 A1
(43) Pub. Date: Nov. 24, 2011

(54) METHOD OF RE-SEARCHING WEBPAGE AND APPARATUS AND STORAGE MEDIUM THEREFOR

(75) Inventor: Chang-seok OH, Suwon-si (KR)

(73) Assignee: Samsung Electronics Co., Ltd., Suwon-si (KR)

(21) Appl. No.: 13/112,735

(22) Filed: May 20, 2011

(30) Foreign Application Priority Data
May 20, 2010 (KR) 10-2010-0047643

(51) Int. Cl. G06F 17/30

(52) U.S. Cl. 707/769; 707/E17.108

(57) ABSTRACT

A method of re-finding a web page in an apparatus capable of web browsing. The method includes storing data of a currently displayed web page as data of a re-search web page in the apparatus when a re-search web page designation signal is received and reading and loading the data of the re-search web page stored in the apparatus when a web page re-search request signal is received.

### PRIORITY

This application claims priority under 35 U.S.C. §119(a) to Korean Patent Application No. 10-2010-0047643, filed on May 20, 2010, in the Korean Intellectual Property Office, the entire disclosure of which is incorporated herein by reference.

### BACKGROUND OF THE INVENTION

1. Field of the Invention

The present invention relates generally to a method of searching a web page, and, more particularly, to a method of re-searching a web page during web browsing and an apparatus and storage medium capable of web browsing by which the method may be performed.

2. Description of the Related Art

During web browsing, a user may search or find a plurality of web pages connected via a hypertext link (hyperlink). When the plurality of web pages are searched, in some cases, previously searched web pages need to be re-searched multiple times. For example, when a user wants to sequentially search a plurality of content in a web page, the web page, including the plurality of content, may be repetitively re-searched.

A bookmark function and a history function may be examples of conventional web page re-search functions or re-find functions. However, to perform the bookmark and history functions, a user needs to remember at least a few keywords by which the user can track and re-search or re-find a desired web page. For example, a user should be aware of IDentification (ID) information used to register a desired web page using the bookmark and history functions so that the user can re-search or re-find the web page.

However, when web pages accessed via a hyperlink are searched in a plurality of hierarchies during web browsing, a user may not remember a web page to re-search. For instance, the user may not remember which web page the user started searching from.

### SUMMARY OF THE INVENTION

The present invention provides a method of re-searching or re-finding a web page by which a desired web page may be directly re-searched or re-found without information regarding the desired web page during web browsing, an apparatus capable of web browsing and executing the method, and a computer-readable storage medium on which a program for executing the method is stored.

The present invention also provides a method of re-searching or re-finding a web page by which a web page having the same content as previously searched or found content may be provided during re-searching or re-finding of the web page, an apparatus capable of executing the method, and a computer-readable storage medium on which a program for executing the method is stored.

According to an aspect of the present invention, there is provided a method of re-searching a web page in an apparatus capable of web browsing. The method includes storing data of a currently displayed web page as data of a re-search web page in the apparatus when a re-search web page designation signal is received and reading and loading the data of the re-search web page stored in the apparatus when a web page re-search request signal is received.

When the web page re-search request signal is received and a web page designated as the re-search web page is open, the method may further include enabling or activating the open web page.

According to another aspect of the present invention, there is provided an apparatus capable of web browsing. The method includes an input unit configured to input a signal or an input, a storage unit configured to store at least data of a re-search web page and IDentification (ID) information regarding the re-search web page, an output unit configured to display web pages, and a processor configured to store data of a web page currently displayed on the output unit as data of the re-search web page in the storage unit when a re-search web page designation signal is received via the input unit during web browsing and read and load the data of the re-search web page stored in the storage unit when a web page re-search request signal is received via the input unit.

According to another aspect of the present invention, there is provided a storage medium having embodied thereon a computer program for executing the above-described method of re-finding a web page, according to an embodiment of the present invention.

### BRIEF DESCRIPTION OF THE DRAWINGS

The above and other features and advantages of the present invention will become more apparent by describing in detail embodiments thereof with reference to the attached drawings, in which:

FIG. 1 is a block diagram illustrating an apparatus capable of web browsing according to an embodiment of the present invention;

FIG. 2 is a flowchart illustrating a method of re-searching a web page in an apparatus capable of web browsing, according to an embodiment of the present invention;

FIG. 3 illustrates a data field of data of a re-search web page stored in a storage unit shown in FIG. 1;

FIG. 4 is a detailed block diagram illustrating a processor shown in FIG. 1;

FIG. 5 is a flowchart illustrating a method of re-searching a web page in an apparatus capable of web browsing, according to another embodiment of the present invention;

FIG. 6 is a flowchart illustrating a method of re searching a web page in an apparatus capable of web browsing, according to another embodiment of the present invention;

FIG. 7 is another detailed block diagram illustrating the processor shown in FIG. 1;

FIG. 8 is a flowchart illustrating a method of re-searching a web page in an apparatus capable of web browsing, according to another embodiment of the present invention;

FIG. 9 is a flowchart illustrating a method of re-searching a web page in an apparatus capable of web browsing, according to another embodiment of the present invention; and

FIG. 10 is a block diagram illustrating functions of a client-server system to which the apparatus capable of web browsing shown in FIG. 1 is applied.

### DETAILED DESCRIPTION OF EMBODIMENTS OF THE PRESENT INVENTION

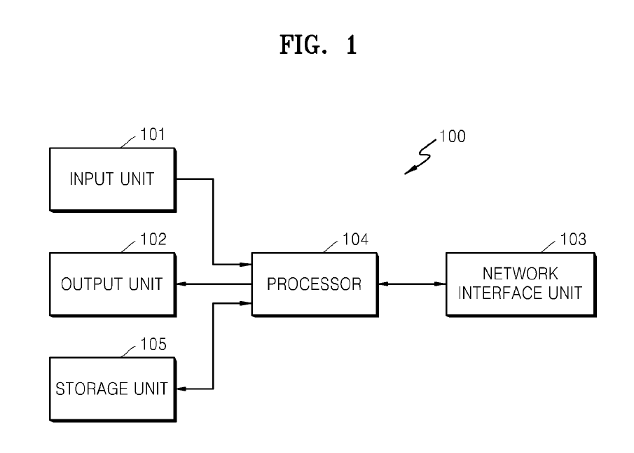

FIG. 1 is a block diagram of an apparatus 100 capable of web browsing according to an embodiment of the present invention.

The apparatus 100 capable of web browsing may be an apparatus on which a web browser may be installed. The apparatus 100 capable of web browsing may be a Personal Computer (PC), an Internet Protocol TeleVision (IPTV), a portable phone, an MP3 Player (MP3P), a navigation device, or a Personal Digital Assistant (PDA), but the apparatus 100 is not limited thereto.

Referring to FIG. 1, the apparatus 100, capable of web browsing, may include an input unit 101, an output unit 102, a network interface unit 103, a processor 104, and a storage unit 105.

The input unit 101 may input signals, such as a touch-based signal, a key-based signal, a mouse step based signal, and a remote controller step based signal. The output unit 102 may output at least an image signal. The input unit 101 and the output unit 102 may be defined as a user interface. When the input unit 101 and the output unit 102 are defined as a touch-panel based user interface, the input unit 101 may be defined as a touch panel, and the output unit 102 may be defined as a display device. Accordingly, the output unit 102 may be a display device, such as a Liquid Crystal Display (LCD) device, a Light-Emitting Diode (LED) display device, or a Cathode-Ray Tube (CRT) display device.

However, the input unit 101 and the output unit 102 are not limited thereto. For example, the output unit 102 may output both an image signal and a voice signal.

An input or a signal that may be input to the input unit 101 according to an embodiment of the present invention may include a web page designation signal or web page selection signal, a web page re-search request signal, and a web browsing end signal, and an output or a signal that may be output by the output unit 102 may include a web page. The web page may be an electronic document formed using web technology, such as HyperText Markup Language (HTML), JavaScript, or a Cascading Style Sheet (CSS).

The network interface unit 103 may enable data to be transmitted and received between a network, such as the Internet, and the apparatus 100. The data transmitted and received by the network interface unit 103 may include web data that may constitute a web page.

The processor 104 may control all functions of the apparatus 100 capable of web browsing. Although the processor 104 may be defined as a controller or microprocessor, the processor 104 is not limited thereto. The processor 104 may be operated based on a loaded web browser. The web browser may be stored in the storage unit 105, which will be described below, or stored in the processor 104. When the web browser is stored in the storage unit 105, the processor 104 may use the web browser stored in the storage unit 105.

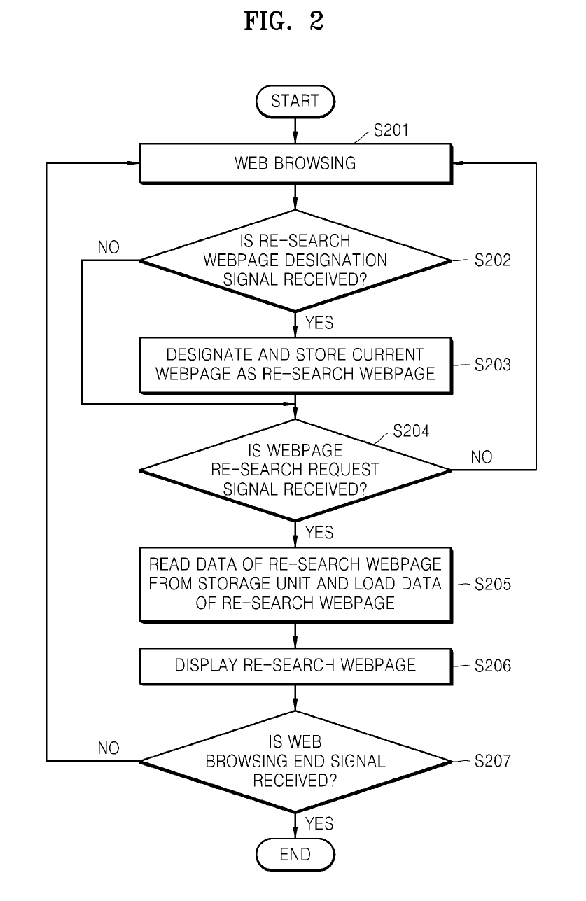

The processor 104 may operate based on the loaded web browser, as described with reference to FIG. 2. FIG. 2 is a flowchart illustrating a method of re-searching a web page in an apparatus capable of web browsing, according to an embodiment of the present invention.

Referring to FIG. 2, the processor 104 may perform web browsing based on the loaded web browser in step S201. When a re-search web page designation or selection signal is received by the input unit 101 during web browsing in step S202, the processor 104 may designate a currently displayed web page (or a current web page) as a web page to be re-searched (or a re-search web page) in the output unit 102 and store data of the designated web page in the storage unit 105 in step S203. IDentification (ID) information regarding the current web page designated as the re-search web page may be stored in the storage unit 105 or temporarily stored in the processor 104.

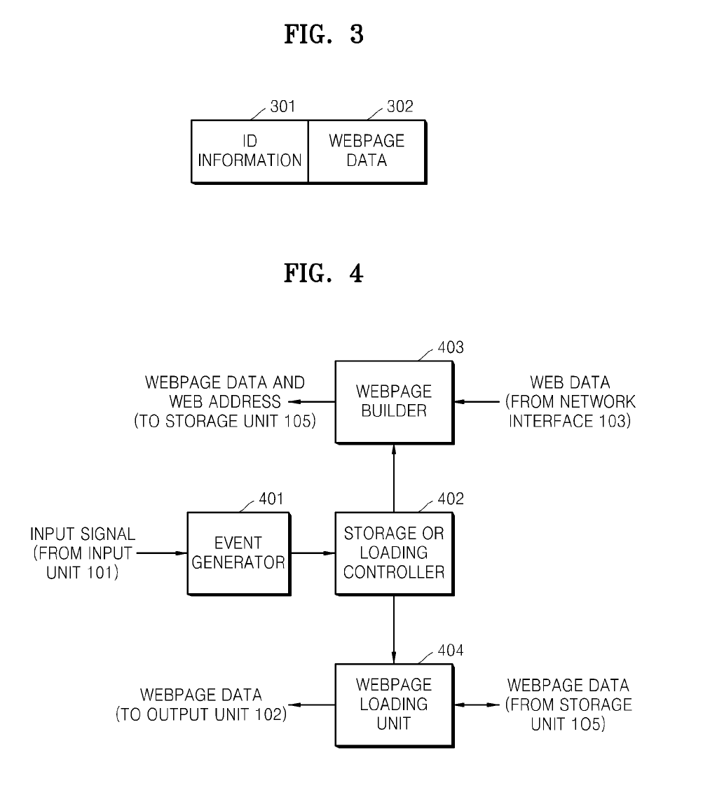

When both the ID information regarding the web page and data of the web page are stored in the storage unit 105, a data field of the data of the re-search web page stored in the storage unit 105 may be defined as shown in FIG. 3. FIG. 3 shows an example of the data field of the data of the re-search web page stored in the storage unit 105. The data field of FIG. 3 may include an ID information field 301 of the re-search web page and a data field 302 of the re-search web page.

The ID information regarding the web page may be, for example, a URL of the web page. The URL may be a Uniform Resource Locator (URL). The data of the web page stored in the storage unit 105 may be data rendered or analyzed based on the web browser or Document Object Model (DOM) data, but the data of the web page is not limited thereto.

In step S204, when the web page re-search request signal has not been received by the input unit 101, the processor 104 goes to step S201 and continuously performs web browsing. However, in step S204, when the web page re-search request signal is received by the input unit 101, the processor 104 may read the data of the re-search web page stored in the storage unit 105 and load the data in step S205. Thus, the re-search web page may be displayed by the output unit 102 in step S206.

As described, the re-search web page is directly designated and stored in response to the re-search web page designation signal, and the stored data of the web page may be directly loaded and displayed in response to the web page re-search request signal, so that the web page designated and stored as the re-search web page can be defined as an instant web page or instant home page.

In step S207, when the web browsing end signal is received, the processor 104 may end web browsing. However, in step S207, when the web browsing end signal has not been received, the processor 104 goes to step S201 and continuously performs web browsing.

When the re-search web page is re-designated (or reselected) as shown in the flowchart of FIG. 2, the processor 104 may change the data of the re-search web page stored in the storage unit 105 into data of a newly designated re-search web page. To this end, when the data of the newly designated re-search web page is stored in the storage unit 105 in step S203, the processor 104 may overwrite the data of the newly designated re-search web page to be stored to the data of the re-search web page stored in the storage unit 105. That is, before the data of the newly designated re-search web page is stored in the storage unit 105, the processor 104 may check if the data of the re-search web page stored in the storage unit 105 is present and overwrite the data of the newly designated re-search web page to the data of the re-search web page stored in the storage unit 105 when the data of the re-search web page stored in the storage unit 105 is present. Step S203 may include checking if the data of the re-search web page stored in the storage unit 105 is present before storing the data of the newly designated web page.

Alternatively, when a specific storage region of the storage unit 105 is previously set as a re-search web page data storage region and the re-search web page designation signal is received, the processor 104 may store data of the web page designated as the re-search web page in the previously set storage region without checking if the data of the re-search web page stored in the storage unit 105 is present. Thus, the storage unit 105 may store data of one re-search web page, which changes in response to the re-search web page designation signal.

Further, step 203 of FIG. 2 may include directly storing data of a current web page in the storage unit 105 without designating the current web page as a re-search web page.

According to the flowchart of FIG. 2, the processor 104 may include the components shown in FIG. 4, which is an example of a detailed block diagram of the processor 104 of FIG. 1. Referring to FIG. 4, the processor 104 may include an event generator 401, a storage or loading controller 402, a web page builder (or a web page constructor) 403, and a web page loading unit 404.

The event generator 401 may generate a re-search web page designation event when the re-search web page designation signal is received by the input unit 101, and generate a web page re-find request event when the web page re-search request signal is received by the input unit 101.

When the re-search web page designation event is generated by the event generator 401, the storage or loading controller 402 may control the web page builder 403 and store a currently built web page and URL in the storage unit 105. The storage or loading controller 402 may temporarily hold or keep the URL without storing the URL in the storage unit 105.

The web page builder 403 may build a web page using web data received from the network interface unit 103. That is, the web page builder 403 may render or analyze (e.g., parse) the received web data using web technology, such as HTML, JavaScript, or CSS, and build or construct the web page.

When the web page re-search request event is generated by the event generator 401, the storage or loading controller 402 may control the web page loading unit 404, read and load the web page stored in the storage unit 105, and display the web page on the output unit 102.

Since the above-described components of the processor 104 are defined based on processes of storing and loading the data of the re-search web page, the processor 104 is not limited to the components shown in FIG. 4.

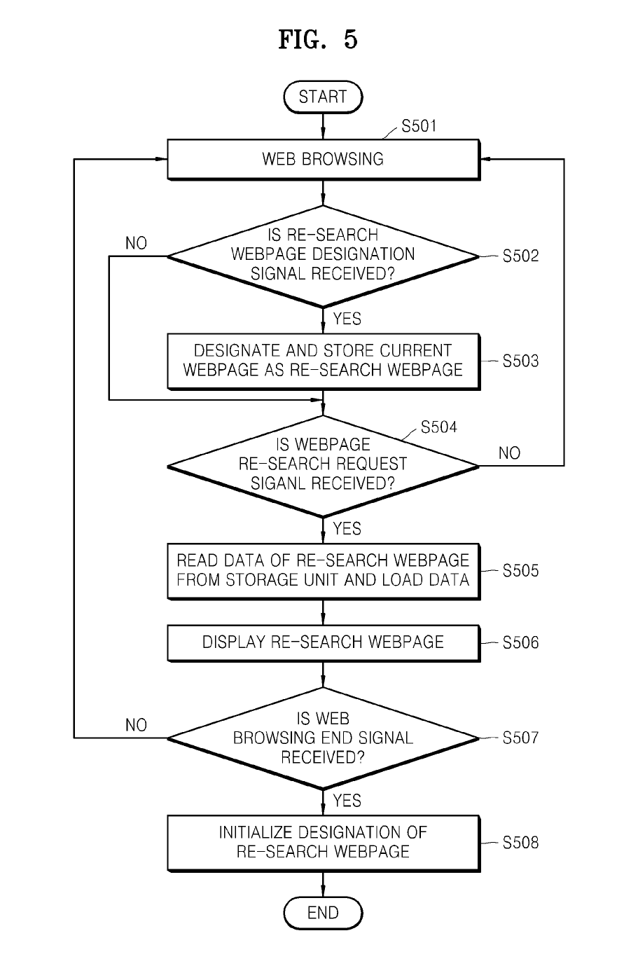

The processor 104 may perform a method of re-searching a web page based on a loaded web browser shown in FIG. 5, which is a flowchart illustrating a method of re-searching a web page in an apparatus capable of web browsing, according to another embodiment of the present invention. The method of FIG. 5 may add initializing designation of the re-search web page to the embodiment shown in FIG. 2. Accordingly, steps S501 through S507 of FIG. 5 are the same as steps S201 to S207 of FIG. 2, respectively.

When a web browsing end signal is received in step S508, the processor 104 may initialize designation of a re-search web page. Thus, information regarding the re-search web page stored in the storage unit 105 may be deleted. Accordingly, step S508 may be defined as a step of deleting information regarding the re-search web page stored in the storage unit 105. Therefore, the designation or selection of the re-search web page according to the embodiment of the present invention may be effective only during web browsing.

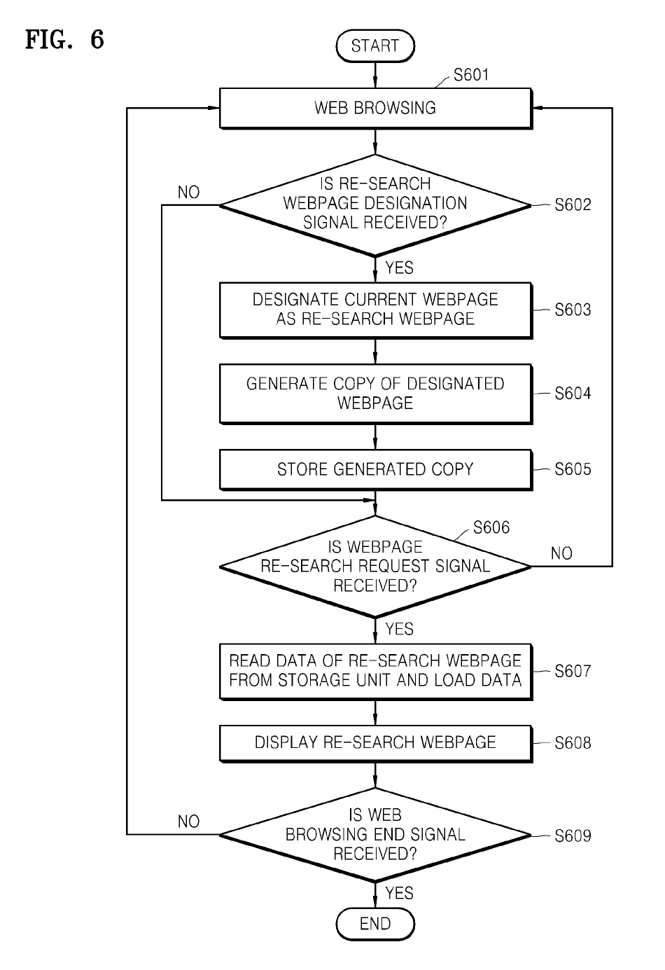

The processor 104 may perform a method of re-searching a web page based on a loaded web browser shown in FIG. 6, which is a flowchart illustrating a method of re-searching a web page in an apparatus capable of web browsing, according to another embodiment of the present invention. The method of FIG. 6 may further include generating a copy of the designated web page and storing the generated copy of the designated web page in the storage unit 105 to the embodiment of FIG. 2. Accordingly, steps S601, S602, and S606 through S609 of FIG. 6 are respectively the same as steps S201, S202, and S204 through S207 of FIG. 2.

When a currently displayed web page is designated as a re-search web page in step S603, the processor 104 may generate a copy of the current web page in step S604. The generation of the copy of the current web page may be performed, copying an original HTML document or be performed using a web editor. When the copy of the current web page is generated, the processor 104 may store the generated copy of the current web page in the storage unit 105 in step S605. The copy of the current web page may be defined as a copy of data of the web page.

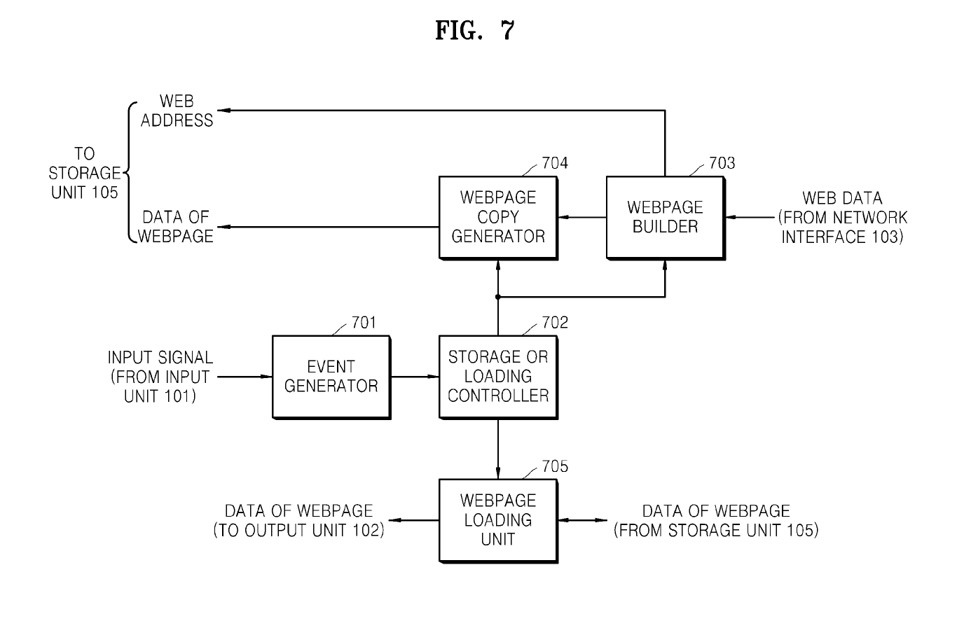

According to the flowchart of FIG. 6, the processor 104 may include the components shown in FIG. 7, which illustrates an example of a detailed block diagram of the processor 104 of FIG. 1. Referring to FIG. 7, the processor 104 may include an event generator 701, a storage or loading controller 702, a web page builder 703, a web page copy generator 704, and a web page loading unit 705. The event generator 701, the storage or loading controller 702, the web page builder 703, and the web page loading unit 705 of FIG. 7 may be configured and operate in the same manner as the event generator 401, the storage or loading controller 402, the web page builder 403, and the web page loading unit 404 of FIG. 4, respectively. However, the web page copy generator 704 may generate a copy using data of a web page output by the web page builder 703 and store the generated copy in the storage unit 105 under the control of the storage or loading controller 702 as shown in FIG. 6.

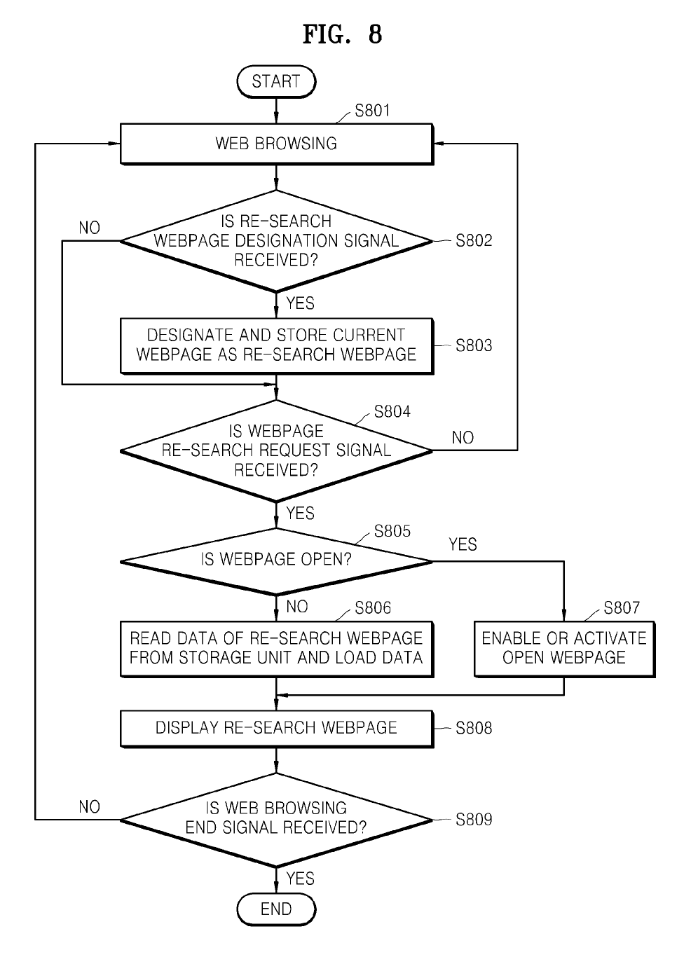

The processor 104 may perform a method of re-searching a web page based on a loaded web browser as shown in FIG. 8, which is a flowchart illustrating a method of re-searching a web page, according to another embodiment of the present invention. In the method of FIG. 8, the web page designated as the re-search web page is open to the embodiment shown in FIG. 2. Accordingly, steps S801 through S803, S808, and S809 of FIG. 8 are the same as steps S201 through S203, S206, and S207 of FIG. 2, respectively.

However, when the web page re-search request signal is received in step S804, the processor 104 may confirm whether the web page designated as the re-search web page is open in step S805. Confirming whether the re-search web page is open may be performed using a URLURL of the re-search web page.

Specifically, the processor 104 may compare each URL of currently open web pages with the URL of the re-search web page and check whether there is any open web page having the same URL as the URL of the re-search web page. Open web pages may include web pages opened using tabs.

When a web page is designated as a re-search web page and the processor 104 stores a URL of the designated web page, the processor 104 may use the stored URL. However, if a web page is designated as a re-search web page and a URL of the designated web page is stored in the storage unit 105, the processor 104 may read the URL stored in the storage unit 105 and perform the above-described comparison step.

When it is determined that the designated web page is not open, the processor 104 may read data of the re-search web page from the storage unit 105 and load the data in step S806. However, when it is determined that the designated web page is open, the processor 104 may enable or activate the open web page in step S807. Thus, the re-search web page may be displayed on the output unit 102 in step S808.

The processor 104 according to the embodiment of FIG. 8 may include the components shown in FIG. 3 and also include a web page open-state determiner (not shown) and an open web page enabling or activating controller (not shown).

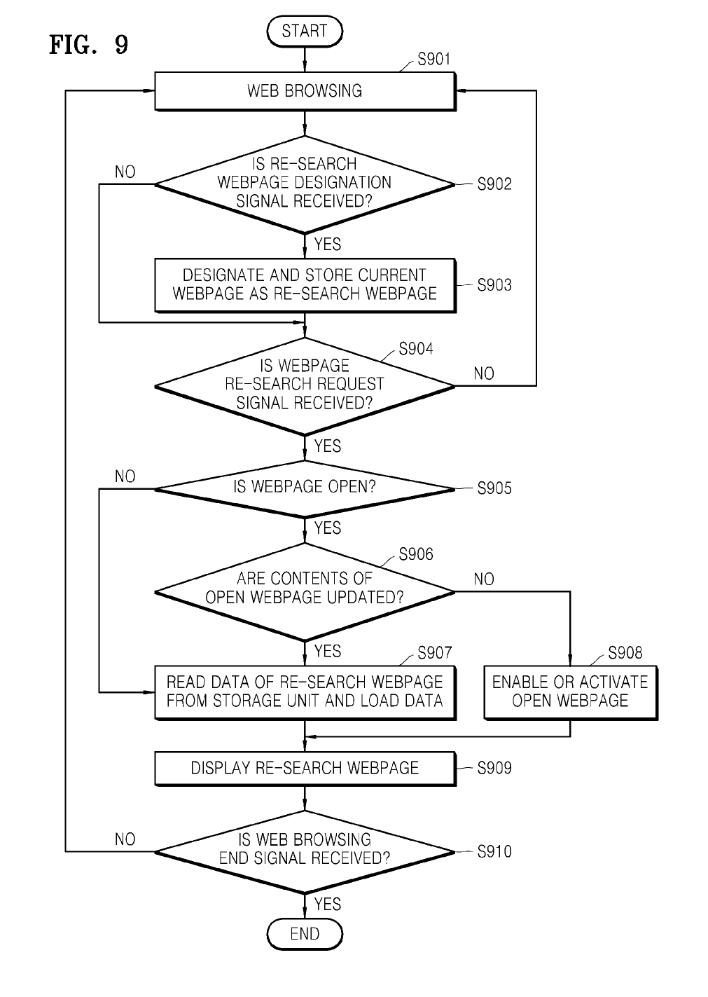

The processor 104 may perform a method of re-searching a web page based on a loaded web browser shown in FIG. 9, which is a flowchart illustrating a method of re-finding a web page, according to another embodiment of the present invention. The method of FIG. 9 may include confirming whether the open web page is updated to the embodiment shown in FIG. 8. Accordingly, steps S901 through S905 and S907 through S910 of FIG. 9 are respectively the same as steps S801 through S809 of FIG. 8.

When it is determined that the re-search web page is open in step S905, the processor 104 may determine whether content of the open web page has been updated in step S906. It may be determined whether the content of the open web page has been updated based on cache information regarding a web browser. Specifically, the web browser may collect a time point at which content of a web server providing the web page has been updated, from the web server based on an expiration time included in the cache information. Therefore, the processor 104 may determine whether the content of the open web page has been updated, based on the cache information.

When it is determined that the content of the open web page has been updated in step S906, the processor 104 may read data of the re-search web page from the storage unit 105 and load the data in step S907. However, when it is determined that the content of the open web page has not been updated in step S906, the processor 104 may enable or activate the open web page in step S908.

The storage unit 105 of FIG. 1 may store at least data of a re-search web page and ID information regarding web pages according to the above-described embodiments. Although the storage unit 105 may adopt a flash memory with a high access speed, the storage unit 105 is not limited thereto.

According to the above-described embodiments, a web page having the same content as when a re-search web page is designated may be re-searched easily and rapidly. Also, a re-search web page may be registered only by a re-search web page designation request and directly searched only by a web page re-search request. Thus, a user may not need to memorize information regarding the re-search web page and register and search the re-search web page simply. The designation and storage of the re-search web page described in the above-described embodiments may be defined as registration of the re-search web page.

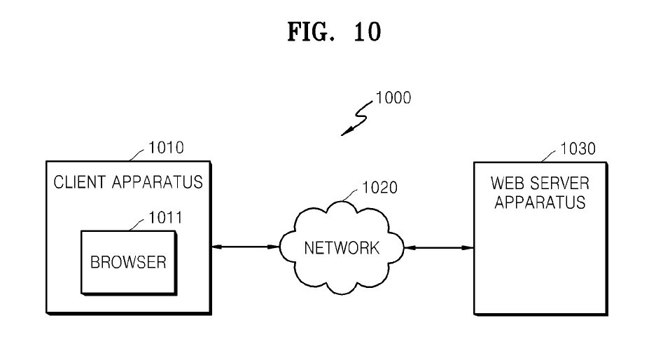

The apparatus 100 capable of web browsing shown in FIG. 1, which may operate with reference to FIGS. 2 through 9, may be applied to a client-server system 1000 of FIG. 10, which is a functional block diagram of a client-server system to which the apparatus capable of web browsing shown in FIG. 1 can be applied.

A client apparatus 1010 including a browser 1011, shown in FIG. 10, may correspond to the apparatus 100 capable of web browsing shown in FIG. 1. Accordingly, when web data capable of building a web page is received from a web server apparatus 1030 via a network 1020, the browser 1011 of the client apparatus 1010 may build the web page based on the received web data and display the web page so that a user can see the web page.

When the web page is displayed on the client apparatus 1010 during the web browsing by the browser 1011, a user operating the client apparatus 1010 may request for designation of a re-search web page, the browser 1011 may store a currently displayed web page as a re-search web page. When a user of the client apparatus 1010 requests to re-search the web page, the browser 1011 may read and load the stored web page and display the web page on the client apparatus 1010.

Thus, when the user of the client apparatus 1010 views a desired re-search web page during web browsing, the user may have only to designate the re-search web page and request to re-search the web page so that the desired web page can be easily re-searched.

The network 1020 may be a wired/wireless communication network. The web server apparatus 1030 may be operated based on a server capable of providing web pages.

A program for executing a method of re-searching a web page, according to an embodiment of the present invention, can be embodied as computer readable codes on a computer-readable recording medium. The computer-readable recording medium is any data storage device that can store data, which can then be read by a computer system. Examples of the computer-readable recording medium include Read-Only Memories (ROMs), Random-Access Memories (RAMs), CD-ROMs, magnetic tapes, floppy disks, and optical data storage devices and the like. The computer-readable recording medium can also be distributed over network-coupled computer systems so that the computer readable code is stored and executed in a distributed fashion.

While the present invention has been particularly shown and described with reference to embodiments thereof, it will be understood by those of ordinary skill in the art that various changes in form and details may be made therein without departing from the spirit and scope of the present invention as defined by the following claims and their equivalents.

What is claimed is:

1. A method of re-searching a web page in an apparatus capable of web browsing, the method comprising:
storing data of a currently displayed web page as data of a re-search web page in the apparatus when a re-search web page designation signal is received; and
reading and loading the data of the re-search web page stored in the apparatus when a web page re-search request signal is received.

2. The method of claim 1, wherein the loaded data of the re-search web page is the same as the stored data of the re-search web page.

3. The method of claim 1, further comprising:
when the web page re-search request signal is received and a web page designated as the re-search web page is open, enabling or activating the open web page.

4. The method of claim 3, wherein enabling or activating of the open web page comprises:
determining whether the web page designated as the re-search web page is open when a web page re-search request event is generated;
determining whether content of the open web page has been updated when the web page designated as the re-search web page is open; and
enabling or activating the open web page when the content of the open web page are not updated.

5. The method of claim 4, wherein when the web page re-search request signal is received and when the web page designated as the re-search web page is not open or the content of the open web page has been updated, the loading the data of the re-search web page.

6. The method of claim 1, wherein storing of the data of the re-search web page comprises:
generating copy of the data of the web page designated as the re-search web page and storing the generated copy of the data in the apparatus.

7. An apparatus capable of web browsing, comprising:
an input unit configured to input a signal or an input;
a storage unit configured to store data of a re-search web page and IDentification (ID) information regarding the re-search web page;
an output unit configured to display web pages; and
a processor configured to store data of a web page currently displayed on the output unit as data of the re-search web page in the storage unit when a re-search web page designation signal is received via the input unit during web browsing and read and load the data of the re-search web page stored in the storage unit when a web page re-search request signal is received via the input unit.

8. The apparatus of claim 7, wherein the data of the web page loaded by the processor in response to the web page re-search request signal is the same as the data of the re-search web page stored in the storage unit.

9. The apparatus of claim 7, wherein when the web page re-search request signal is received and the web page designated as the re-search web page is open, the processor enables or activates the open web page.

10. The apparatus of claim 9, wherein the processor determines whether the re-search web page is open when the web page re-search request signal is received, determines whether content of the open web page has been updated when the re-search web page is open, and enable the open web page when the content of the open web page are not updated.

11. The apparatus of claim 10, wherein when the web page re-search request signal is received, and when the web page designated as the re-search web page is not open or the content of the open re-search web page has been updated, the processor reads and loads the data of the re-search web page stored in the storage unit.

12. The apparatus of claim 7, wherein the processor generates the copy of the data of the web page designated as the re-search web page and stores the copy data in the storage unit.

13. A non-transitory storage medium having embodied thereon a computer program for executing the method, the method comprising:
storing data of a currently displayed web page as data of a re-search web page in the apparatus when a re-search web page designation signal is received; and
reading and loading the data of the re-search web page stored in the apparatus when a web page re-search request signal is received.
